(19) United States
(12) Patent Application Publication
(10) Pub. No.: US 2025/0292748 A1
(43) Pub. Date: Sep. 18, 2025

(54) DRUMHEAD DAMPENER APPARATUS FOR A DRUMKIT

(71) Applicant: Tandem Instruments LLC, Novato, CA (US)

(72) Inventor: Daniel Watson Kushner, Novato, CA (US)

(21) Appl. No.: 19/080,447

(22) Filed: Mar. 14, 2025

Related U.S. Application Data
(60) Provisional application No. 63/565,138, filed on Mar. 14, 2024.

(51) Int. Cl. G10D 13/14

(52) U.S. Cl. CPC G10D 13/14

(57) ABSTRACT

A drumhead dampener apparatus includes a dampener assembly and an attachment arm. The dampener assembly includes: a pouch; and a weight media arranged within the pouch. The attachment arm includes a center section and a boss. The center section: is configured to extend over a rim of a drum; and includes a distal end coupled to the pouch of the dampener assembly. The boss: extends downwardly from a proximal end of the center section opposite the dampener assembly; is configured to receive and compress against a tension rod, extending from a hoop of the drum; and is configured to locate the dampener assembly at a distance on a drumhead from a rim of the drum. The dampener assembly is configured to induce an active dampening effect to reduce overtones while allowing resonance from an impact transient to propagate from the drum.

### CROSS-REFERENCE TO RELATED APPLICATIONS

This application claims the benefit of U.S. Provisional Application No. 63/565,138, filed on 14 Mar. 2024, which is hereby incorporated in its entirety by this reference.

### TECHNICAL FIELD

This invention relates generally to the field of drumkit dampeners and, more specifically, to a new and useful active gate drumhead dampener apparatus in the field of drumkit dampeners.

### BRIEF DESCRIPTION OF THE FIGURES

FIG. 1 is a schematic representation of a drumhead dampener apparatus;

FIG. 2 is a schematic representation of the drumhead dampener apparatus;

FIG. 3 is a schematic representation of the drumhead dampener apparatus;

FIG. 4 is a schematic representation of the drumhead dampener apparatus;

FIG. 5 is a schematic representation of the drumhead dampener apparatus;

FIGS. 6A, 6B and 6C are schematic representations of the drumhead dampener apparatus;

FIG. 7 is a schematic representation of the drumhead dampener apparatus;

FIGS. 8A and 8B are schematic representations of the drumhead dampener apparatus;

FIG. 9 is a schematic representation of the drumhead dampener apparatus;

FIGS. 10A, 10B, and 10C are schematic representations of the drumhead dampener apparatus;

FIGS. 11A and 11B are schematic representations of the drumhead dampener apparatus;

FIGS. 12A and 12B are schematic representations of the drumhead dampener apparatus;

FIG. 13 is a schematic representation of the drumhead dampener apparatus;

FIGS. 14A and 14B are schematic representations of the drumhead dampener apparatus; and

FIG. 15 is a schematic representation of the drumhead dampener apparatus.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. DRUMHEAD DAMPENER APPARATUS

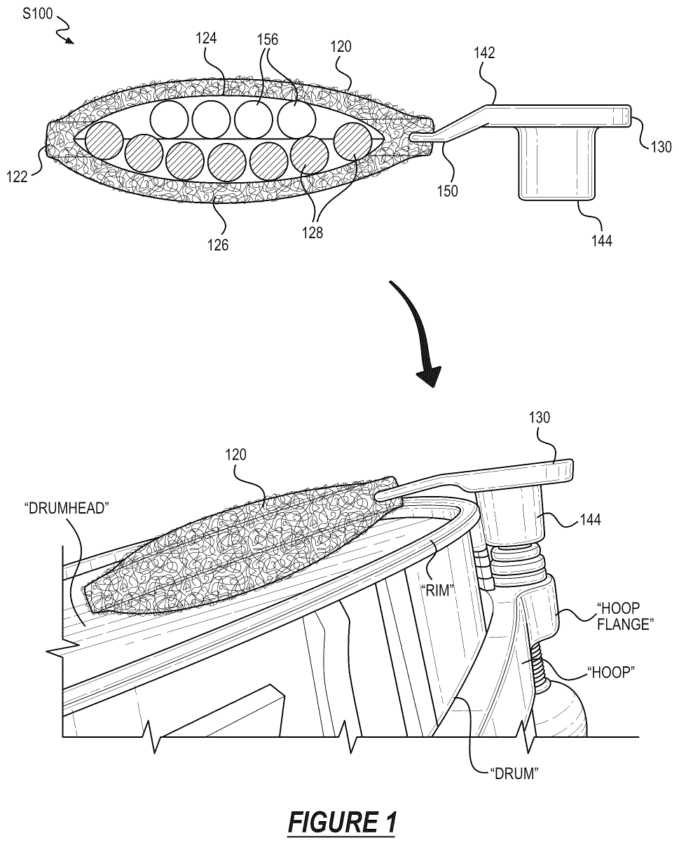

As shown in FIG. 1, a drumhead dampener apparatus 100 for a drumkit includes: a dampener assembly 120; and an attachment arm 130.

The dampener assembly 120 includes a pouch 122 (e.g., a felt pocket) including: a primary layer 124 (e.g., a primary felt layer); and a secondary layer 126 (e.g., a secondary felt layer) coupled (e.g., stitched, seamed, bonded, molded) to a periphery of the primary layer 124 to form an internal volume. The dampener assembly 120 further includes a weight media 128 (e.g., a set of steel ball bearings) arranged within the internal volume of the pouch 122.

The attachment arm 130 includes: a center section 142; and a primary boss 144. The center section 142: is configured to extend over a rim of a drum (e.g., a snare drum, a tom drum); and includes a distal end coupled (e.g., stitched, seamed) to the pouch 122 of the dampener assembly 120. The primary boss 144: extends downwardly from a proximal end of the center section 142 opposite the dampener assembly 120; is configured to receive and compress against a tension rod, extending from a hoop (e.g., a counter hoop) of the drum; and is configured to locate the dampener assembly 120 at a primary distance on a drumhead (e.g., a batter head, a resonant head) from a rim of the drum.

The dampener assembly 120, located across a drumhead of the drum by the attachment arm 130, is configured to induce an active dampening effect to reduce (or “choke”) overtones while allowing resonance from an impact transient to propagate from the drum.

### 1.1 Drumhead+Cymbal Dampener Apparatus

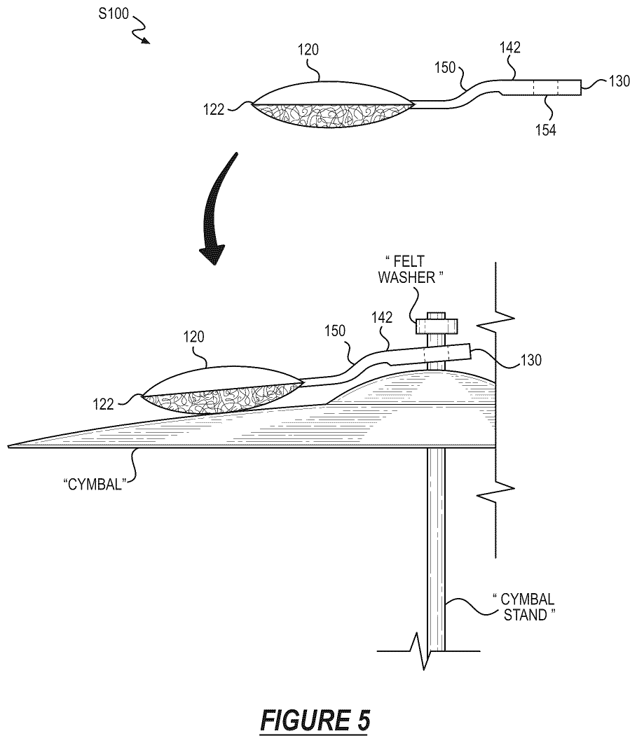

In one variation of the drumhead dampener apparatus 100, shown in FIG. 5, the attachment arm 130 includes an aperture 154: located proximal the primary boss 144 at the proximal end of the center section 142; configured to receive a mounting post, from a cymbal seat supporting a cymbal (e.g., crash, ride, hi-hat); configured to locate the attachment arm 130 on the cymbal; and configured to locate the dampener assembly 120 on a surface of the cymbal. Accordingly, in this variation, the dampener assembly 120, located on a surface of the cymbal by the attachment arm 130, is configured to induce an active dampening effect to reduce (or “choke”) overtones while allowing resonance from an impact transient to propagate from the cymbal.

### 1.2 Stepped Center Section

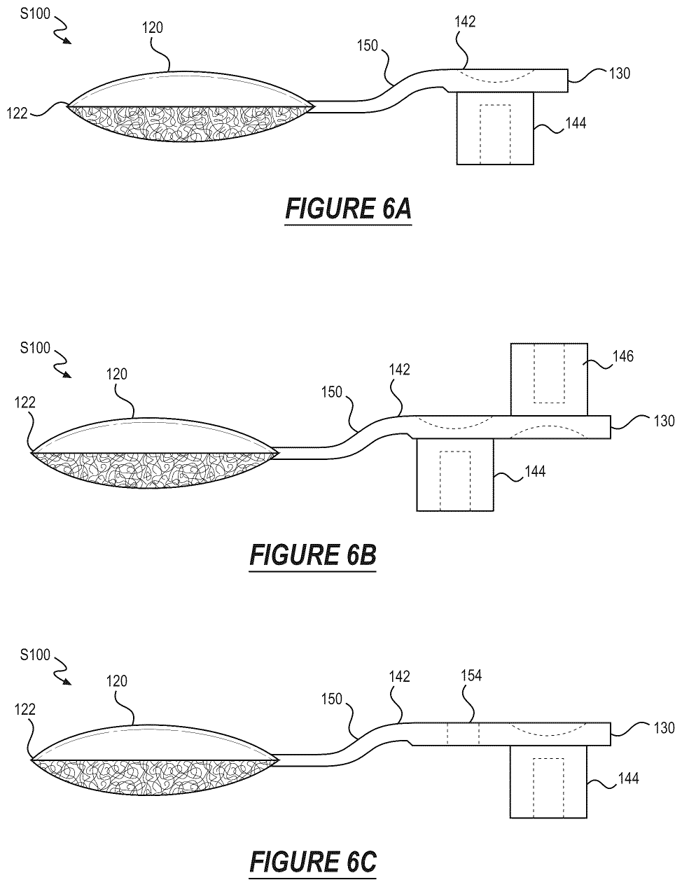

In another variation of the drumhead dampener apparatus 100, shown in FIGS. 6A-6C, the center section 142 includes a step 150 (e.g., incline step) arranged between the primary boss 144 and the dampener assembly 120. The step 150 is configured to: bridge a height difference between the tension rod and the surface of the drumhead of the drum maintain a distal segment of the center section 142, adjacent the dampener assembly 120, parallel to the surface of the drumhead; and reduce torque applied by the weight media to the boss, via the center section, orthogonal to an axis of the tension rod.

### 1.3 Double Opposing Bosses

In another variation of the drumhead dampener apparatus 100, shown in FIG. 6B, the attachment arm 130 includes a secondary boss 146: interposed between the primary boss 144 and the dampener assembly 120; extending opposite the primary boss 144; and configured to insert over a tension rod, about the hoop of the drum (e.g., a snare drum, a tom drum) to locate the dampener assembly 120 at a secondary distance on the drumhead from the rim of the drum. In this variation, the primary boss 144 is configured to insert over the tension rod to locate the dampener assembly 120 at the primary distance, greater than the secondary distance, from the rim of the drum.

### 2. APPLICATIONS

Generally, the drumhead dampener apparatus 100 functions as an active gate dampener transiently mountable to a drumkit to reduce (or “choke”) overtones from a drum (e.g., a snare drum, a tom drum) or a cymbal (e.g., a crash, a ride, a hi-hat) in the drumkit while allowing resonance from an impact transient to propagate from the drumkit. More specifically, the drumhead dampener apparatus 100 includes: a dampener assembly 120 including a pouch 122 (e.g., a felt pouch 122) and a weight media 128 (e.g., ball bearings, a steel plate) arranged within the pouch 122; and an attachment arm 130 coupled to the dampener assembly 120 and including a primary boss 144 configured to transiently couple the attachment arm 130 to a tension rod on a drum (e.g., snare drum, tom drum), thereby locating the dampener assembly 120 across a drumhead of the drum.

Accordingly, oscillations across the drumhead of the drum—such as from striking the drum with a drumstick (e.g., timbal sticks, mallets, brushes)—are transferred to the dampener assembly 120 and thus, result in the dampener assembly 120 vibrating across the drumhead of the drum. During vibration of the dampener assembly 120 across the surface of the drumhead, the dampener assembly 120 briefly (e.g., 20 milliseconds) separates from the surface of the drumhead, thereby enabling the drumhead to resonate. Upon subsequent contact of the dampener assembly 120 to the surface of the drumhead, the dampener assembly 120 further absorbs oscillations across the drumhead, thereby reducing acoustic resonance of the drum. Thus, the drumhead dampener apparatus 100 induces an active gate dampener effect to reduce (or “choke”) overtones from the drum (e.g., snare drum, tom drum) while allowing resonance from an impact transient, such as in response to a strike (e.g., via a drumstick) on the drum by a drummer, to propagate from the drum. Accordingly, the active gate dampening effect varies as a function of the impact force applied to the drumhead, such that higher impact forces extend the sustain phase of transient vibrations prior to attenuation.

In one example, the attachment arm 130: is formed of an elastomeric material (e.g., a thermoplastic polyurethane, silicone); and includes a center section 142 and a primary boss 144. The primary boss 144: is arranged at a proximal end of the center section 142; extends orthogonal the attachment arm 130; and includes a cylindrical boss wall defining a diameter less than a diameter of a tension rod arranged at the drum. The dampener assembly 120 includes: a pouch 122 (e.g., a felt pouch 122) coupled (e.g., stitched, seamed) to a distal end, opposite the proximal end, of the center section 142; and includes a weight media (e.g., steel bearings) arranged within the pouch 122. Accordingly, the primary boss 144 is undersized for the tension rod of the drum, thereby: forming a compression fit between the primary boss 144 and the tension rod when mounted to the drum; and locating the dampener assembly 120 across the drumhead of the drum. In this example, oscillations across the drumhead—such as from striking the drumhead—are transferred to the set of ball bearings of the dampener assembly 120 to induce vibration of the dampener assembly 120 across the drumhead of the drum.

Accordingly, as the dampener assembly 120 vibrates across the drumhead, the dampener assembly 120 reduces (or “chokes”) resonance while allowing overtones from an impact transient to propagate from the drum. Therefore, rather than maintaining contact between the dampener assembly 120 and the drumhead of the drum with adhesive to reduce (or “choke”) acoustic overtones, the dampener assembly 120: vibrates across the surface of the drumhead responsive to resonant oscillations; is weighted against the drumhead; allows resonance from an impact transient to propagate from the drum; and includes an elastic or compressible interface (i.e., the pouch 122) between the drumhead and the weight media 128, which together yields active dampening of acoustic resonance of the drumhead of the drum.

Alternatively, rather than including the weight media 128 arranged within the compressible interface, the system can include the weight media 128: arranged within a rigid interface (e.g., steel plate, glass, metal); coupled to the attachment arm 130; and arranged across the drumhead of the drum.

### 2.1 Applications: Cymbal Dampener

In one implementation, the attachment arm 130 can include an aperture 154 configured to receive a cymbal mounting post, thereby transiently coupling the attachment arm 130 to the cymbal and locating the dampener assembly 120 on a surface of the cymbal. The drumhead dampener apparatus 100 can similarly induce an active gate dampener effect to reduce (or “choke”) overtones while allowing resonance from an impact transient, such as in response to a strike on the cymbal, to propagate from the cymbal.

In one example, the attachment arm 130 is formed of an elastomeric material (e.g., thermoplastic polyurethane, silicone); and includes a center section 142 and an aperture 154 (e.g., a circular aperture 154). The aperture 154: is arranged at a proximal end of the center section 142; and extends through the attachment arm 130. The dampener assembly 120 includes: a pouch 122 (e.g., felt pouch 122) coupled (e.g., stitched, seamed) to a distal end, opposite the proximal end, of the center section 142; and includes a set of ball bearings (e.g., metallic ball bearings arranged within the pouch 122. Accordingly, the aperture 154 is configured to receive a mounting post—of a cymbal seat supporting a cymbal—to: locate the attachment arm 130 over a bell of the cymbal at the cymbal seat; and locate the dampener assembly 120 across a surface of the cymbal.

In this example, oscillations across the surface of the cymbal—such as from striking the cymbal—are transferred to the set of ball bearings of the dampener assembly 120 to induce vibration of the dampener assembly 120 across the surface of the cymbal. Accordingly, as the dampener assembly 120 vibrates across the surface of the cymbal, the dampener assembly 120 reduces (or “chokes”) resonance while allowing overtones from an impact transient to propagate from the cymbal. Therefore, rather than maintaining contact between the dampener assembly 120 and the surface of the cymbal with adhesive to reduce (or “choke”) acoustic overtones, the dampener assembly 120: vibrates across the surface of the cymbal responsive to resonant oscillations; is weighted against the surface of the cymbal; allow resonance from an impact transient to propagate from the cymbal; and includes an elastic or compressible interface (i.e., the pouch 122) between the surface of the cymbal and the weight media 128, which together yields active dampening of acoustic resonance of the surface of the cymbal.

### 2.2 Applications: Closed Gate Effect

In another implementation, rather than the dampener assembly inducing an active gate effect, the dampener assembly 120 is configured to—in response to application of an impact on the drumhead—induce a closed gate dampener effect that: attenuates propagation of transient impact vibrations from the drumhead during exciting vibration of the weight media on the drumhead; and attenuates propagation of residual harmonic vibrations from the drumhead during damping vibration of the set of weight elements on the drumhead. In this variation, the closed gate dampening effect remains substantially independent of the applied impact force, with transient vibrations of the weighted media diminishing rapidly due to continuous surface contact between the dampener assembly 120 and the drumhead.

For example, the drumhead dampener apparatus 100 can include a rigid attachment arm 130 configured to maintain contact of the dampener assembly 120 with the drumhead during application of an impact on the drumhead. In another example, the drumhead dampener apparatus 100 can include a weight media 128 that is configured to maintain contact of the pouch 122 with the drumhead during application of an impact on the drumhead. In yet another example, the drumhead dampener apparatus 100 includes a flexible dampening layer 160 extending across the drumhead and configured to maintain contact with the drumhead during application of the impact on the drumhead.

### 3. ATTACHMENT ARM

Generally, the drumhead dampener apparatus 100 includes: an attachment arm 130 configured to transiently couple to a drum (e.g., snare drum, tom drum) and a cymbal (e.g., crash, ride, hi-hat) of a drumkit; and a dampener assembly 120 coupled to the attachment arm 130 and configured to locate across the drumhead of the drum (e.g., snare drum, tom drum) and the surface of the cymbal (e.g., crash, ride, hi-hat). In particular, the attachment arm 130 can include: a center section 142; and a primary boss 144 extending from a proximal end of the center section 142 and configured to receive a tension rod about the hoop, such as at a hoop flange, of the drum to locate the dampener assembly 120 across the drumhead. Additionally or alternatively, the center section 142: can include an aperture 154 at the proximal end of the center section 142 and extending through the attachment arm 130; and is configured to receive a threaded post of a cymbal mount to locate the dampener assembly 120 across the surface of the cymbal. Thus, the drumhead dampener apparatus 100 can induce an active dampening effect to reduce acoustic resonance responsive to striking the drum and the cymbal, such as striking the drumhead of the drum (e.g., snare drum, tom drum) via a drumstick (e.g., timbal sticks, brushes, mallets) and/or striking the cymbal (e.g., surface, bell, edge of the cymbal) via the drumstick.

### 3.1 Attachment Arm: Drum Mount

In one implementation, shown in FIG. 6A, the drumhead dampener apparatus 100 includes an attachment arm 130 including: a center section 142; a primary boss 144 arranged at a proximal end of the center section 142; and a dampener assembly 120 arranged at a distal end, opposite the proximal end, of the center section 142. The primary boss 144 is configured to transiently couple to a tension rod of the drum (e.g., snare drum, tom drum) to locate the dampener assembly 120 across the drumhead of the drum.

In one example, the attachment arm 130 includes: a unitary structure formed of an elastomeric material (e.g., thermoplastic polyurethane, silicone) within a durometer range of 75 and 85; and the primary boss 144 (e.g., cylindrical boss) extending from a primary side of the attachment arm 130 configured to receive a tension rod of a drum (e.g., snare drum, tom drum) to locate the dampener assembly 120 across the drumhead of the drum. In this example, the primary boss 144 defines: a cylindrical boss wall extending (e.g., 10 millimeters) from the primary side of the attachment arm 130; and a pilot hole extending within the cylindrical boss wall and configured to receive a tension rod head of a tension rod, in a set of tension rods, arranged about the hoop of the drum (e.g., snare drum, tom drum).

In this example, the pilot hole of the primary boss 144 defines a target diameter (e.g., between 4.5 millimeters and 5.5 millimeters) less than a diagonal dimension of a tension rod head (e.g., less than one millimeter) arranged about the hoop of the drum. Accordingly, the tension rod head receives the pilot hole to locate the tension rod head within the primary boss 144 and thus form a compression fit (or “pressure-fit”) between the primary boss 144 and the tension rod head to retain the dampener assembly 120 across the drumhead of the drum. Therefore, the attachment arm 130 can transiently couple to the set of tension rods—radially arranged about the hoop of the drum—to locate the dampener assembly 120 across the drumhead of the drum and thus form an active gate dampener to dampen oscillations across the drumhead. The attachment arm 130 forms the compression fit (or “pressure-fit”) to the tension rod of the drum to enable a user to: couple and remove the drumhead dampener apparatus 100 with a single hand; and transiently retain the drumhead dampener apparatus 100 at the drum.

### 3.1.1 Dual Boss

In another implementation, shown in FIG. 6B, the drumhead dampener apparatus 100 includes an attachment arm 130 including: a center section 142; a primary boss 144 arranged at a proximal end of the center section 142 and extending from a primary side of the attachment arm 130; a secondary boss 146 extending from a secondary side, opposite the primary side, of the attachment arm 130 and linearly offset from the primary boss 144 on the center section 142; and a dampener assembly 120 arranged at a distal end, opposite the proximal end, of the attachment arm 130. This primary boss 144 and the secondary boss 146 are configured to transiently couple (e.g., interference fit) to the tension rod of the drum (e.g., snare drum, tom drum) to locate the dampener assembly 120 across the drumhead of the drum. In this implementation, the attachment arm 130 enables alternation between a primary mounting configuration and a secondary mounting configuration to selectively locate the dampener assembly 120 across the drumhead respective the hoop of the drum. In a primary mounting configuration, the primary boss 144 receives a tension rod head to locate the dampener assembly 120 at a primary offset distance (e.g., three inches) from the hoop of the drum. Alternatively, in a secondary mounting configuration, the secondary boss 146 receives the tension rod head to locate the dampener assembly 120 at a secondary offset distance (e.g., two inches), less than the primary offset distance from the hoop of the drum. Thus, the attachment arm 130 enables for alternate mounting configurations across a set of tension rods about the hoop of the drum to selectively locate active damping regions across the drumhead of the drum.

### 3.2 Drum Mount: Multiple Dampener Assemblies

In one implementation, a primary drumhead dampener apparatus 100 includes a primary attachment arm 130 including: a primary center section 142; and a primary boss 144. The primary boss 144: is arranged at a proximal end of the primary center section 142; and extends from a primary side of the center section 142. The primary drumhead dampener apparatus 100 further includes a primary dampener assembly 120 arranged at a distal end, opposite a proximal end, of the center section 142. As described above, the primary attachment arm 130 is configured to transiently couple a primary tension rod—in a set of tension rods radially arranged about the hoop of the drum—to locate the primary dampener assembly 120 across a primary dampening region of the drumhead of the drum. Additionally, a secondary drumhead dampener apparatus 100 includes a secondary attachment arm 130 including: a secondary center section 142; and a secondary boss 146. The secondary boss 146: is arranged at a proximal end of the secondary center section 142; and extends from a primary side of the center section 142. The secondary drumhead dampener apparatus 100 further includes a secondary dampener assembly 120 arranged at a distal end, opposite the proximal end, of the secondary center section 142. In this implementation, the secondary attachment arm 130 is configured to transiently couple a secondary tension rod—in the set of tension rods radially arranged about the hoop of the drum—radially offset from the primary tension rod to locate the secondary dampener assembly 120 across a secondary dampening region of the drumhead of the drum. Therefore, the primary dampener assembly 120 of the primary drumhead dampener apparatus 100 and the secondary dampener assembly 120 of the secondary drumhead dampener apparatus 100 cooperate to reduce (or “choke”) overtones while allowing resonance from an impact transient to propagate from the drum.

### 3.3 Attachment Arm: Cymbal Mount

In one implementation, shown in FIG. 5, the drumhead dampener apparatus 100 includes an attachment arm 130 including: a center section 142; and an aperture 154 arranged at a proximal end of the center section 142. The drumhead dampener apparatus 100 further includes a dampener assembly 120 arranged at a distal end, opposite the proximal end, of the center section 142. The aperture 154 is configured to transiently couple to a cymbal post (e.g., hi-hat stand, tilted cymbal post) to locate the dampener assembly 120 across the surface of a cymbal (e.g., crash, ride, hi-hat) mounted to the cymbal post. In one example, the attachment arm 130: is a unitary structure formed of an elastomeric material (e.g., thermoplastic polyurethane, silicone) within a durometer range of 75 and 85; and includes the aperture 154 arranged at the proximal end of the center section 142 and configured to receive a mounting post extending from a cymbal seat, such as a cymbal seat arranged on a tilter of a cymbal post and a cymbal arranged at a hi-hat stand, to locate the dampener assembly 120 across the surface of the cymbal. In this example, the aperture 154: defines a target diameter (e.g., 1 centimeter) in order to receive the mounting post of the cymbal seat; and receives the mounting post to locate the attachment arm 130 and the dampener assembly 120 extending across the surface of the cymbal. In this configuration, the attachment arm 130 is interposed between the cymbal and a felt washer arranged at the cymbal seat of the cymbal post. Therefore, the attachment arm 130 can transiently couple to the cymbal seat of a cymbal post—including a cymbal mounted to the cymbal seat—to locate the dampener assembly 120 across the surface of the cymbal and thus form an active gate dampener to dampen oscillations across the surface of the cymbal.

In another implementation, the drumhead dampener apparatus 100 includes an attachment arm 130 including: a primary aperture 154 extending through the attachment arm 130 and arranged at the proximal end of the center section 142; and a secondary aperture 154 arranged on the center section 142 and linearly offset from the primary aperture 154. The dampener assembly 120 is arranged at the distal end, opposite the proximal end, of the attachment arm 130. The primary aperture 154 and the secondary aperture 154 are configured to transiently couple to the cymbal seat of a cymbal post to locate the dampener assembly 120 across the surface of a cymbal (e.g., crash, ride).

In this implementation, the attachment arm 130 enables alternation between a primary mounting configuration and a secondary mounting configuration to selectively locate the dampener assembly 120 across the surface of the cymbal respective the bell of the cymbal. In a primary mounting configuration, the primary aperture 154 receives the mounting post of the cymbal seat to locate the dampener assembly 120 at a primary offset distance (e.g., three inches) from the bell of the cymbal. Alternatively, in a secondary mounting configuration, the secondary aperture 154 receives the mounting post of the cymbal seat to locate the dampener assembly 120 at a secondary offset distance (e.g., two inches), less than the primary offset distance from the bell of the cymbal. Thus, the attachment arm 130 enables radial offset mounting configurations about the surface of the cymbal to selectively locate active damping regions across the surface of the cymbal.

### 3.4 Attachment Arm: Drum+Cymbal Mount

In one implementation, shown in FIG. 6C, the drumhead dampener apparatus 100 includes an attachment arm 130 including: a center section 142; an aperture 154 extending through the attachment arm 130 and arranged at a proximal end of the center section 142; and a primary boss 144 extending from a primary side of the center section 142 and linearly offset from the aperture 154. The dampener assembly 120 is arranged at a distal end, opposite the proximal end, of the attachment arm 130. In this implementation, the attachment arm 130 can enable alternation between a primary mounting configuration of the drumhead dampener apparatus 100 to a drum and a secondary mounting configuration of the drumhead dampener apparatus 100 to a cymbal post. In the primary mounting configuration, the aperture 154 receives a mounting post of a cymbal seat (e.g., hi-hat cymbal seat, tilter cymbal seat) arranged on a cymbal post to locate the dampener assembly 120 across the surface of the cymbal (e.g., crash, ride, hi-hat). In the secondary mounting configuration, the primary boss 144 receives a tension rod head of a tension rod—in a set of tension rods radially arranged about the hoop of the drum (e.g., snare drum, tom drum)—to locate the dampener assembly 120 across the drumhead of the drum. Therefore, a user can selectively mount the drumhead dampener apparatus 100 to a drum (e.g., snare drum, tom drum) or a cymbal (e.g., crash, ride, hi-hat) via the attachment arm 130.

### 3.5 Drum Mount: Batter Head+Resonant Head

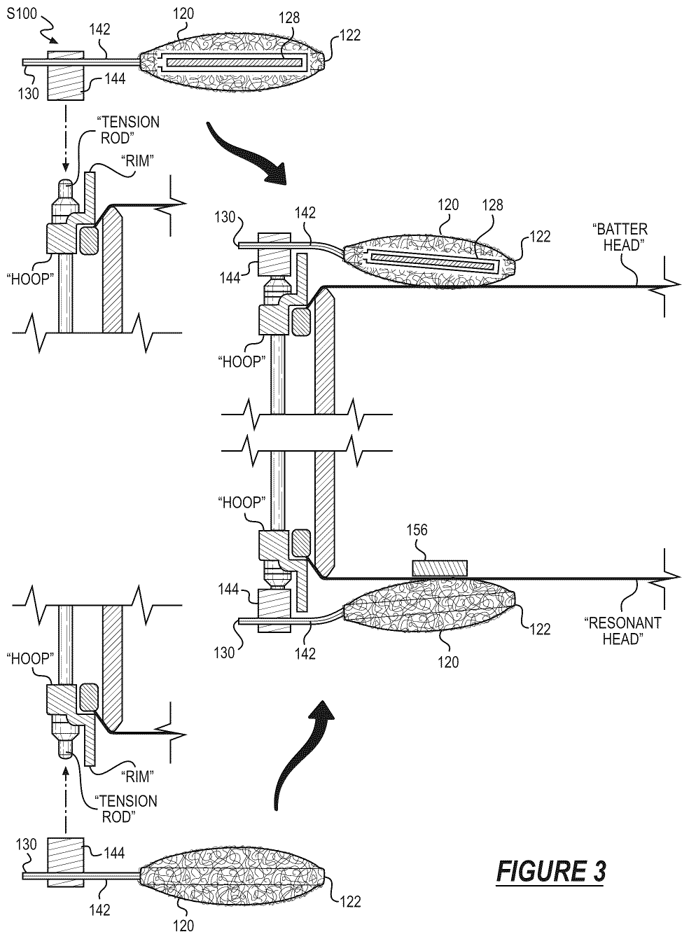

In one implementation, shown in FIG. 3, the drumhead dampener apparatus 100 is operable between: a batter head configuration to induce the active gate-dampening effect for vibrations propagating from a batter head of the drum; and a resonant head configuration to induce the active gate-dampening effect for vibrations propagating from a resonant head of the drum.

As described above, in the batter head configuration, the primary boss 144 is configured to: receive and compress against a primary end of the primary tension rod extending from the hoop of the drum; and locate the dampener assembly 120 at the primary distance on a batter head from the rim of the drum. Alternatively, in the resonant head configuration, the primary boss 144 is configured to: receive and compress against a secondary end, opposite the primary end, of the tension rod extending from the hoop of the drum; and locate the dampener assembly 120 at a secondary distance on a resonant head, opposite the batter head, from the rim of the drum. In the resonant head configuration, the attachment arm 130 can be configured to locate and maintain the dampener assembly 120 proximal the resonant head. Additionally or alternatively, the drumhead dampener apparatus 100 can include a magnetic element 156 configured to magnetically couple the dampener assembly 120 to the resonant head.

Therefore, the drumhead dampener apparatus 100 is configured to selectively couple to tension rods arranged about the drum in order to selectively induce the active gate-dampening effect at the batter head and/or the resonant head of the drum.

### 3.6 Stepped Attachment Arm

In one implementation, shown in FIG. 1, the drumhead dampener apparatus 100 includes an attachment arm 130 including: a center section 142; and a primary boss 144 arranged at a proximal end of the center section 142. The dampener assembly 120 is arranged at a distal end, opposite the proximal end, of the attachment arm 130. In this implementation, the center section 142 defines a step portion 150 (e.g., incline) extending between the proximal end including the primary boss 144 and the distal end including the dampener assembly 120. Accordingly, the attachment arm 130 is configured to: receive the primary boss 144 at a tension rod about the hoop of the drum; locate the incline portion of the attachment arm 130 extending over the hoop of the drum toward the drumhead of the drum; and locate the dampener assembly 120—coupled to the attachment arm 130—across the drumhead of the drum to form an active gate dampener.

### 3.7 Rigid Segment+Flexible Segment

In one implementation, the attachment arm 130 includes: a center section 142 defining a rigid segment proximal the primary boss 144; and a flexible segment proximal the dampener assembly 120. In this implementation, the rigid segment: is characterized by a rigid durometer range (e.g., between Shore D 60-90); defines a primary thickness (e.g., eight millimeters and ten millimeters); and is configured to maintain compression of the primary boss 144 against the primary tension rod during vibration of the weight media 128 within the pouch 122. Additionally, the flexible segment: is characterized by a flex durometer range (e.g., between Shore A 30-60); defines a secondary thickness (e.g., five millimeters and seven millimeters) less than the primary thickness; and is configured to flex (or “yield”) during vibration of the weight media 128 within the pouch 122 to induce the active gate-dampening effect. Accordingly, during the active gate-dampening effect, the rigid segment blocks transmission of vibrations across the flexible segment to the primary boss 144 in order to prevent loosening and slipping of the compression fit between the primary boss 144 and the tension rod of the drum.

### 4. DAMPENER ASSEMBLY

Generally, the drumhead dampener apparatus 100 includes a dampener assembly 120 configured to locate across a drumhead of a drum (e.g., snare drum, tom drum) to form an active gate dampener to dampen oscillations across the drumhead responsive to striking (e.g., via a drumstick) of the drum. Similarly, the dampener assembly 120 is configured to locate across the surface of a cymbal (e.g., crash, ride, hi-hat) to form an active gate dampener to dampen oscillations across the cymbal surface responsive to striking (e.g., via a drumstick) of the cymbal. In particular, the dampener assembly 120 can include: a pouch 122 (e.g., felt pouch 122) coupled to the attachment arm 130 and configured to contact the surface of the drumhead of the drum; and a weight media 128 (e.g., ball bearings, steel plate) arranged within the pouch 122 and configured to maintain the pouch 122 in nominal contact with the surface of the drumhead. Accordingly, the drumhead dampener apparatus 100 induces an active dampener effect responsive to oscillations across the drumhead of the drum.

### 4.1 Active Gate

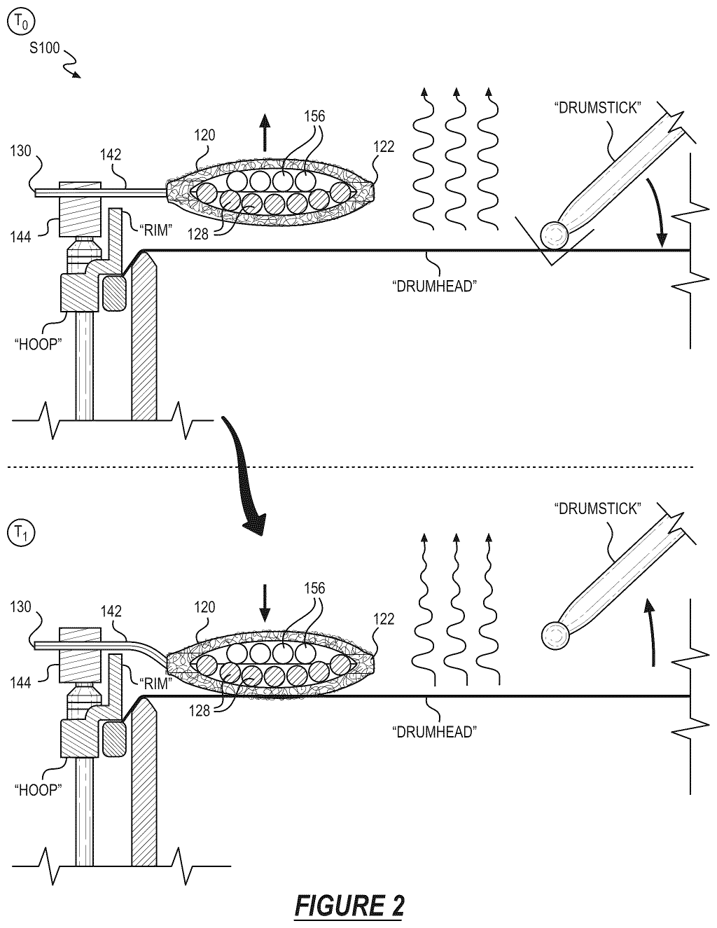

As shown in FIG. 2, striking the drum (e.g., snare drum, tom drum), such as striking (e.g., via a drumstick) the drumhead or the hoop of the drum, induces resonant oscillations across the drumhead of the drum. In one implementation, the drumhead dampener apparatus 100 is configured to: transiently couple the drum to locate the dampener assembly 120 across the surface of the drumhead of the drum; and induce an active dampener effect—responsive to oscillations across the drumhead—to reduce (or “choke”) acoustic overtones while allowing resonance from an impact transient to propagate from the drum. Similarly, striking the cymbal (e.g., crash, ride, hi-hat), such as striking (e.g., via a drumstick) the bell, surface, edge, of the cymbal, induces resonant oscillations across the cymbal. In this implementation, the drumhead dampener apparatus 100 is configured to: transiently couple the cymbal seat of a cymbal post to locate the dampener assembly 120 across the surface of the cymbal; and induce an active dampener effect—responsive to oscillations across the surface of the cymbal—to reduce (or “choke”) acoustic overtones while allowing resonance from an impact transient to propagate from the cymbal.

For example, responsive to striking of the drum, the drumhead dampener apparatus 100 can: absorb oscillations across the drum at the dampener assembly 120 arranged across the drumhead of the drum; and induce vibration of the dampener assembly 120—according to absorbed oscillations from the drum—over the drumhead of the drum. During vibration of the dampener assembly 120 across the surface of the drumhead, the dampener assembly 120 briefly (e.g., 20 milliseconds) separates from the surface of the drumhead, thereby enabling the drumhead to resonate. Upon subsequent contact of the dampener assembly 120 to the surface of the drumhead, the dampener assembly 120 further absorbs oscillations across the drumhead, thereby reducing acoustic resonance of the drum. Therefore, rather than adhesively maintaining contact of the dampener assembly 120 across the drumhead of the drum (e.g., snare drum, tom drum) to reduce (or “choke”) acoustic overtones, the dampener assembly 120 vibrates across the surface of the drumhead responsive to resonant oscillations to actively dampen acoustic overtones and allow resonance from an impact transient to propagate from the drum.

Similarly, responsive to striking of the cymbal, the drumhead dampener apparatus 100 can: absorb oscillations across the cymbal at the dampener assembly 120 arranged across the surface of the cymbal; and induce vibration of the dampener assembly 120—according to absorbed oscillations from the cymbal—over the surface of the cymbal. Thus, as described above, the drumhead dampener apparatus 100 induces an active damping effect as the dampener assembly 120 vibrates across the cymbal to reduce (or “choke”) acoustic overtones while allowing resonance from an impact transient to propagate from the cymbal.

In one implementation, the drumhead dampener apparatus 100 defines a dampening threshold proportional to: a weight media 128 (e.g., steel plate, ball bearings) of the dampener assembly 120; a mass (e.g., 20, 40, 60, 120, 200 grams) of the dampener assembly 120 coupled to the attachment arm 130; a durometer (e.g., 80 durometer) of the attachment arm 130; and a length of the attachment arm 130 extending across the drumhead of the drum. Accordingly, as the mass of the dampener assembly 120 and the durometer of the attachment arm 130 increases, the dampening threshold of the drumhead dampener apparatus 100 decreases. Therefore, the drumhead dampener apparatus 100 can include variations of mass and durometer corresponding to dampening thresholds for reducing (or “choking”) acoustic resonance from a drum or cymbal.

### 4.1.1 Dampening Threshold

In one implementation, the dampener assembly 120 defines a dampening threshold (e.g., between 50 and 200 Hertz) proportional to: a mass of the weight media 128; a durometer of the attachment arm 130; and the primary distance on the drumhead from the rim of the drum. In one implementation, following application of the impact on the drumhead, the dampener assembly 120 is configured to: in response to the transient-induced vibration of the weight media 128 within the pouch 122 exceeding the dampening threshold, sustain propagation of transient impact vibrations from the drumhead over a primary duration of time; and, in response to decaying vibration of the weight media 128 within the pouch 122 falling below the dampening threshold, attenuate propagation of residual harmonic vibrations from the drumhead over a secondary duration of time following the primary duration of time.

Thus, the drumhead dampener apparatus 100 can induce an active dampening effect characterized by a dampening threshold that defines a transition timing between sustaining transient impact vibrations and attenuating residual vibrations propagating from the drumhead of the drum.

### 4.2 Weight Media: Ball Bearings

In one implementation, shown in FIGS. 1 and 2, the drumhead dampener apparatus 100 includes a dampener assembly 120 including: a pouch 122 (e.g., felt pouch 122) coupled (e.g., stitched, seamed) to the attachment arm 130 configured to contact with the surface of the drumhead; and a set of ball bearings (e.g., metallic ball bearings arranged within the pouch 122 and configured to resonate responsive to oscillations across the drumhead, such as oscillations across the drumhead from striking the drum with a drumstick.

In this implementation, the dampener assembly 120 can absorb oscillations across the drumhead of the drum (e.g., snare drum, tom drum) in order to reduce resonance of the drum, such as from striking the drumhead or the hoop of the drum. In particular, the dampener assembly 120 can: transfer oscillations across the drumhead of the drum to the set of ball bearings arranged within the pouch 122; vibrate across the surface of the drumhead; and maintain contact with the surface of the drumhead to reduce resonance from the drum. Similarly, the dampener assembly 120 can absorb oscillations across the surface of the cymbal (e.g., crash, ride, hi-hat) in order to reduce resonance of the cymbal, such as from striking the bell, surface, or edge of the cymbal. In particular, the dampener assembly 120 can: transfer oscillations across the surface of the cymbal to the set of ball bearings arranged within the pouch 122; vibrate across the surface of the cymbal; and maintain contact with the surface of the cymbal to reduce resonance from the cymbal.

In one example, the pouch 122 includes: a primary layer 124 (e.g., rectangular, circular felt layer) spanning a target area (e.g., between 2.5 and 5.0 square inches); and a secondary layer 126 (e.g., rectangular, circular felt layer) spanning the target area and coupled (e.g., stitched, seamed) about the periphery of the primary layer 124 to form the pouch 122 configured to receive the set of ball bearings. In this example, the dampener assembly 120 includes the set of ball bearings arranged within the pouch 122 to define a target mass (e.g., 40, 60, 120, 200 grams) configured to rest (e.g., by gravity) upon the drumhead of the drum. The drumhead dampener apparatus 100 defines a dampening threshold proportional to the mass of the dampener assembly 120 applied across the drumhead of the drum or surface of the cymbal. Accordingly, a drumhead dampener apparatus 100, including a dampener assembly 120 of a 40-gram mass, defines a dampening threshold greater than a dampening threshold for a dampener assembly 120 of a 200-gram mass.

Therefore, the drumhead dampener apparatus 100 can include a dampener assembly 120 including a set of ball bearings (e.g., metallic ball bearings configured to: absorb oscillations across the surface of the drumhead of a drum; and induce vibration of the dampener assembly 120 across the surface of the drumhead to reduce (or “choke”) acoustic overtones while allowing resonance from an impact transient to propagate from the drum.

### 4.2.1 Resonance

In one implementation, as shown in FIG. 1, the weight media 128 further includes a set of magnetic elements 156: arranged within the internal volume of the pouch 122; interspersed with the set of ball bearings within the internal volume; and configured to magnetically couple to the set of ball bearings to attenuate vibration of the set of ball bearings within the pouch 122 in response to external environmental vibrations independent of impact on the drumhead of the drum. In this implementation, resonant frequencies of external vibrations, such as from instrument amplifiers, speakers, and subwoofers, can result in uncontrolled vibration and buzzing of the weight media 128 within the pouch 122. Accordingly, the set of magnetic elements 156 magnetically couples to the set of ball bearings to define a passive resonance modifier (or “frequency shifter”) that adjusts a resonant frequency of the set of ball bearings to prevent uncontrolled vibration and buzzing of the weight media 128.

In one example, the set of magnetic elements 156 defines a ten percent ratio with a total quantity of the set of ball bearings (e.g., 10 magnetic elements, 100 ball bearings) arranged within the pouch 122. In another example, the set of magnetic elements 156 defines a twenty percent ratio with a total mass of the set of ball bearings arranged within the pouch 122.

Therefore, the dampener assembly 120 includes a set of magnetic elements 156 cooperating with the weight media 128 to define a passive resonance modifier that passively shifts a resonant frequency of the weight media 128 to prevent uncontrolled vibration and buzzing of the weight media 128.

### 4.3 Embedded Weight Media

In one implementation, shown in FIG. 3, the drumhead dampener apparatus 100 includes: a plate (e.g., steel plate) defining a target mass (e.g., 40, 60, 120, 200 grams); and an attachment arm 130 overmolded (e.g., injection molded) about the plate to form a unitary structure. In this implementation, the attachment arm 130 is overmolded about the plate to locate: the primary boss 144 at a proximal end of the center section 142; and the plate arranged at a distal end, opposite the proximal end, of the center section 142.

In this implementation, the drumhead dampener apparatus 100 further includes a pouch 122 (e.g., felt pouch 122) coupled (e.g., seamed, stitched) to the distal end of the center section 142 to envelop the plate embedded within the attachment arm 130. For example, the pouch 122 can include: a primary layer 124 (e.g., rectangular, circular felt layer) arranged over the primary side of the attachment arm 130 at the distal end including the plate; and a secondary layer 126 (e.g., rectangular, circular felt layer) arranged below the secondary side of the attachment arm 130 at. As described above, the primary boss 144 of the attachment arm 130 can receive a tension rod at the drum to locate the primary layer 124 of the pouch 122, and therefore the plate, across the drumhead of the drum. As described above, the drumhead dampener apparatus 100 can: transfer oscillations across the surface of the drumhead to the plate arranged within the pouch 122; vibrate across the surface of the drumhead; and maintain intermittent contact with the surface of the drumhead to reduce resonance from the drum.

Therefore, the drumhead dampener apparatus 100 can include a dampener assembly 120 including a plate configured to: absorb oscillations across the surface of the drumhead of the drum; and induce vibration of the dampener assembly 120 across the surface of the drumhead to reduce (or “choke”) acoustic overtones while allowing resonance from an impact transient to propagate from the drum.

### 4.4 Center Section Coupling: Slot

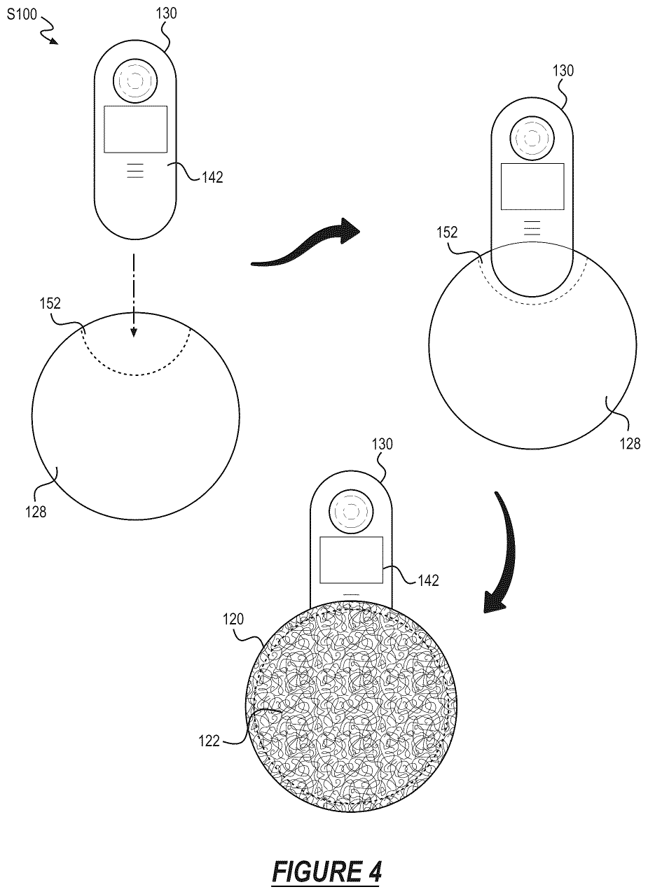

In one implementation, shown in FIG. 4, the dampener assembly 120 includes: a unitary weight media (e.g., a plate) defining a slot 152 configured to receive the distal end of the center section 142; and a unitary dampener layer 160 (e.g., a felt layer). For example, the slot 152 can be formed (e.g., via milling, laser cutting) into the unitary weight media and cooperates with the distal end of the center section 142 to form a structurally unified interface between the center section 142 and the weight media 128. In this implementation, the dampener assembly 120 further includes a unitary damper layer: enveloping the unitary weight media; coupled to the distal end of the center section 142 of the attachment arm 130; and configured to contact the drumhead of the drum.

Accordingly, during assembly of the drumhead dampener apparatus 100, the distal end of the center section 142 is coupled (e.g., adhesively bonded) to the slot 152 of the weight media 128. The unitary damper layer is then arranged about the weight media 128 and coupled (e.g., stitched) to an interface region of the center section 142. Therefore, rather than just coupling to the pouch 122 of the dampener assembly 120, the drumhead dampener apparatus 100 includes a unitary weight media coupled to the center section 142 in order to reduce resonant vibrations within the pouch 122 resulting from resonant frequencies of external vibrations independent from the impact transient on the drumhead.

### 5. VARIATION: KEYS

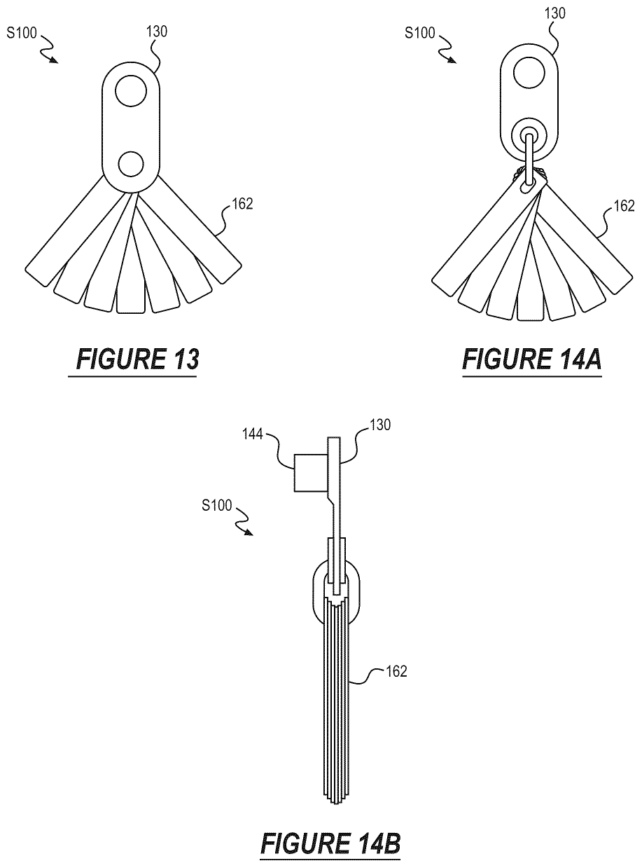

In one variation, shown in FIGS. 13, 14A and 14B, the drumhead dampener apparatus 100 can include: an attachment arm 130 including a primary boss 144 arranged at a proximal end of the center section 142 and configured to transiently couple to a tension rod about a hoop of a drum; and a dampener assembly 120 including a set of rigid components 162 (e.g., metal keys, looped steel rings) arranged at a distal end, opposite the proximal end of the center section 142, and configured to locate across the drumhead of the drum.

For example, the drumhead dampener apparatus 100 can include: an aperture 154 at the distal end extending through the center section 142; and the set of rigid components 162 (e.g., metal keys, looped steel rings) looped through the aperture 154 to locate the set of rigid components 162 (e.g., metal keys, looped steel rings) across the drumhead of the drum. In another example, the set of rigid components 162 is coupled (e.g., via a barbell, a carabiner) to the distal end of the center section 142.

In this implementation, the drumhead dampener apparatus 100 can: transfer oscillations across the surface of the drumhead to the set of rigid components 162 (e.g., metal keys, looped steel rings); vibrate across the surface of the drumhead; and maintain intermittent contact with the surface of the drumhead to reduce (or “choke”) overtones while allowing resonance—from an impact transient—to propagate from the drum. Therefore, the drumhead dampener apparatus 100 is configured to induce an active gate dampener effect during vibration of the drum.

However, the dampener assembly 120 can include any other variation of weight media 128, such as weighted ball bearings, steel plates, key rings, to induce the active gate dampener effect during vibration of the drum.

### 6. VARIATION: SURFACE DAMPENER

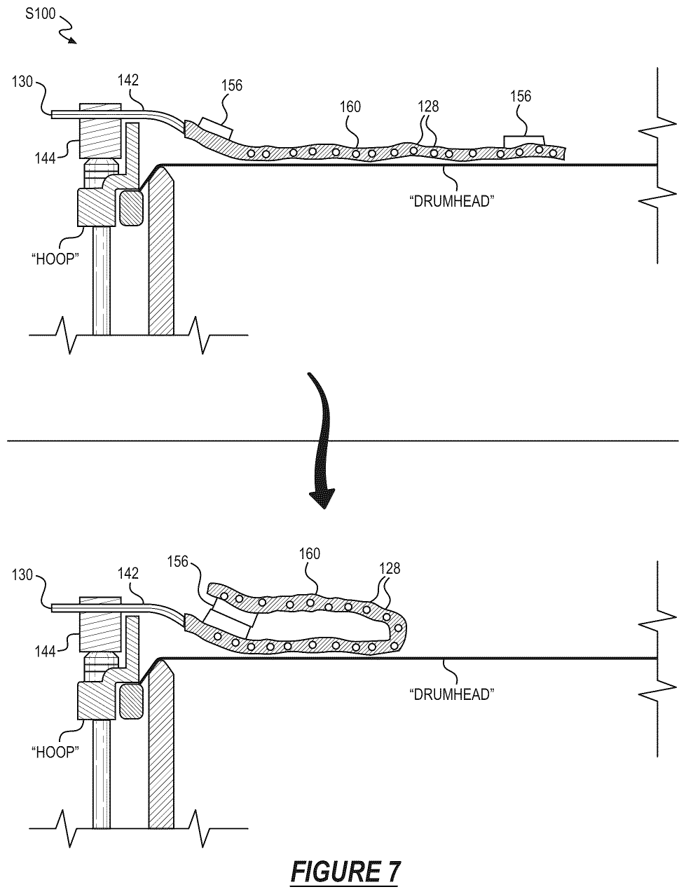

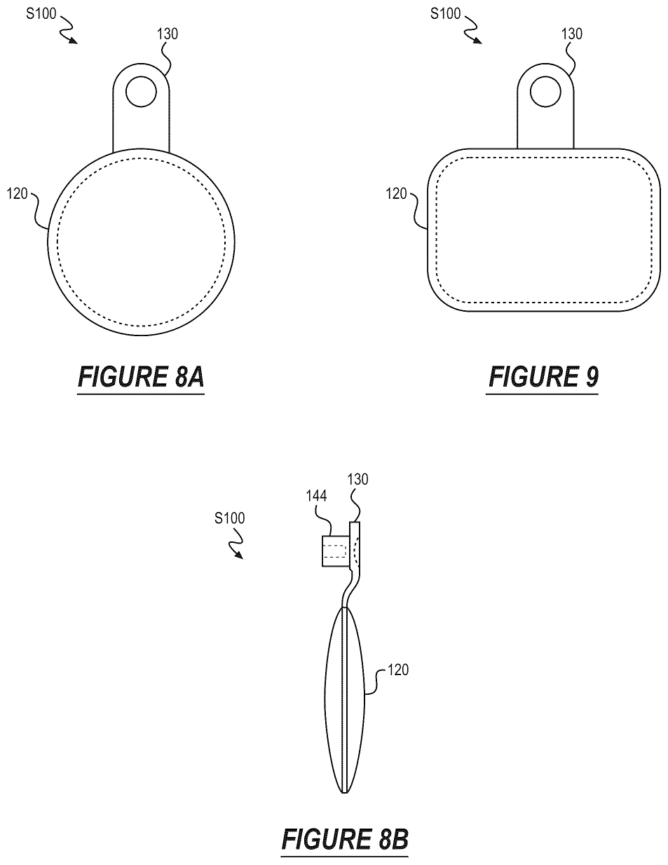

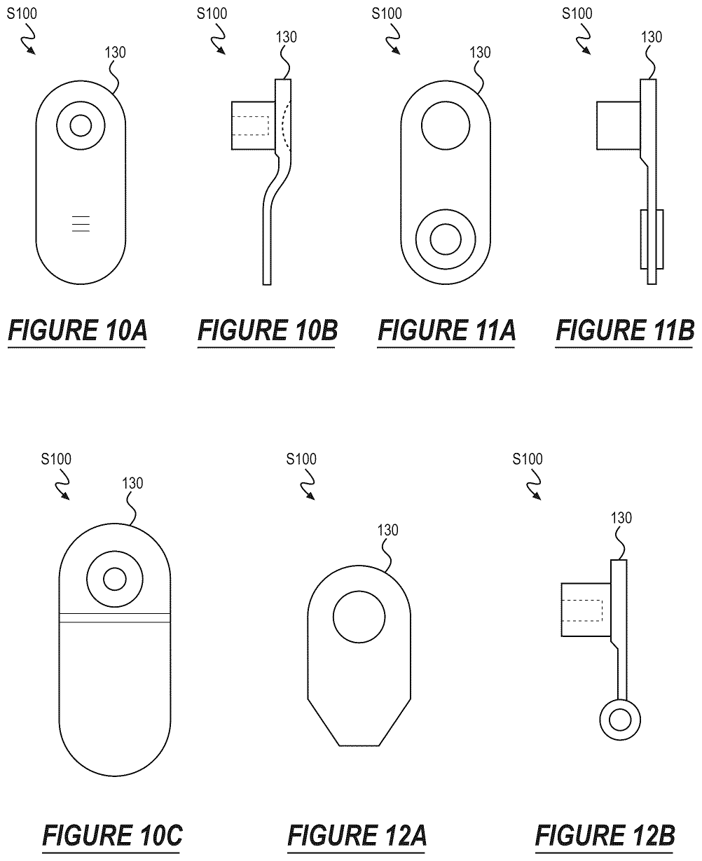

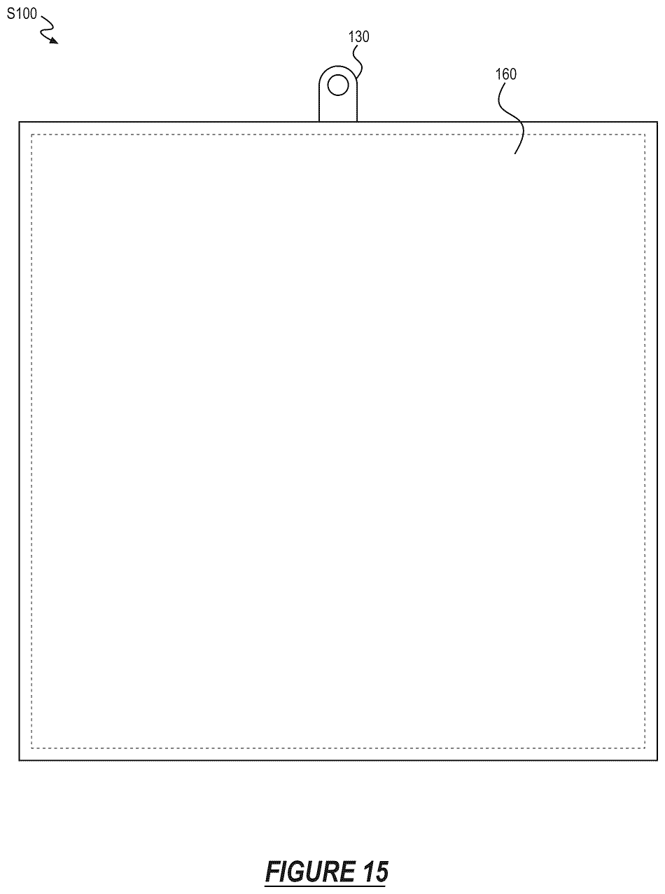

In one implementation, as shown in FIGS. 7 and 15, the dampener assembly 120 includes a flexible dampener layer 160 (e.g., a cloth layer) defining a primary contact surface across a global region of the drumhead. In this implementation, the attachment arm 130 includes: the distal end of the center section 142 coupled (e.g., stitched) to an edge of the flexible dampener layer 160; and the primary boss 144 extending downwardly from the proximal end of the center section 142 opposite the flexible dampener layer 160. The primary boss 144 is configured to: receive and compress against the tension rod extending from the hoop of the drum; and locate the flexible dampener layer 160 across the global region of the drumhead from the rim of the drum.

Accordingly, in response to application of an impact on the drumhead, the flexible dampener layer 160 is configured to induce the active gate-dampening effect that: sustains propagation of transient impact vibrations from the drumhead during exciting vibration of the flexible dampener layer 160 over the global region of the drumhead; and attenuates propagation of residual harmonic vibrations from the drumhead during damping vibration of the flexible dampener layer 160 over the global region of the drumhead. Therefore, rather than inducing the active gate-dampening effect at a localized region of the drumhead, the drumhead dampener apparatus 100 can include a surface vibratory element to induce the active gate-dampening effect across a global region of the drumhead.

In this variation, the drumhead dampener apparatus 100 can implement the structure described above for the dampener assembly 120 and the attachment arm 130 to induce the active gate-dampening effect across the drumhead of the drum.

### 6.1 Impregnated Weight Media

In one implementation, as shown in FIG. 7, the weight media 128: includes a set of discrete weight elements impregnated within the flexible dampening layer; and is configured to maintain contact of the flexible dampener layer 160 across the global region of the drumhead. For example, the weight media 128 can include discrete weight elements (e.g., metallic pellets, ceramic beads) embedded within the flexible dampener layer 160. In another example, the weight media 128 can include an impregnated viscoelastic coating infused with high-density particles.

Therefore, the flexible dampener layer 160 can include an impregnated weight media 128 configured to vibrate in response to an impact transient on the drumhead to induce the active gate-dampening effect across the global region of the drumhead.

### 6.2 Folded Configuration

In one implementation, as shown in FIG. 7, the drumhead dampener apparatus 100 includes a flexible dampener layer 160 configured to transition between an unfolded configuration and a folded configuration to selectively modify dampening characteristics of a drumhead. In this implementation, the flexible dampener layer 160 includes: a primary magnetic element arranged proximal a primary edge of the flexible dampener layer 160; and a secondary magnetic element arranged proximal a secondary edge, opposite the primary edge, of the flexible dampener layer 160.

During operation in the unfolded configuration, the flexible dampener layer 160: is arranged across a primary region of the drumhead; and engages the primary contact surface with the drumhead to induce a broad active gate-dampening effect across the primary region. Alternatively, during operation in the folded configuration, the primary magnetic element magnetically couples to the primary magnetic element to: retract a portion of the flexible dampener layer 160 from the drumhead; reduce a contact area of the flexible dampener layer 160 across the drumhead; and define a secondary contact surface across a secondary region, less than the primary region, on the drumhead to induce the active gate-dampening effect over a reduced surface area of the drumhead.

Therefore, a user can selectively transition operation of the drumhead dampener apparatus 100 between the folded and unfolded configurations to selectively adjust propagation of transient impact vibrations and overtones across the drumhead.

### 7. VARIATION: TRIGGERS

In one variation, the drumhead dampener apparatus 100: includes a trigger (e.g., transducer) arranged on the dampener assembly 120; and configured to register strikes applied to the drum or cymbal, such as strikes applied to the drumhead and/or counter hoop of the drum, and strikes applied to the surface of the cymbal. In this variation, the drumhead dampener apparatus 100 cooperates with a computer system (e.g., trigger interface, trigger module) to: register a stroke applied to the drum; correlate the stroke to an audio sample (e.g., audio wave file) in an audio library stored at the computer system; and output the audio sample from the computer system, such as to a speaker.

In one example, the drumhead dampener apparatus 100 includes: a printed circuit board (e.g., flexible printed circuit board) coupled to the center section 142 (e.g., embedded, overmolded) of the attachment arm 130; a dampener assembly 120 arranged on a distal end of the center section 142 and defining a primary side configured to locate across the surface of the drumhead of the drum; the trigger (e.g., transducer) arranged on the primary side of the dampener assembly 120 proximal the drumhead of the drum; a connecter (e.g., wired connection) coupled to the trigger arranged at a proximal end, opposite the distal end, of the center section 142; and a primary boss 144 extending downwardly from a proximal end of the center section 142 opposite the dampener assembly 120 and configured to locate the dampener assembly 120—and therefore the trigger—at a primary distance on a drumhead from a rim of the drum. In this example, the computer system can couple the trigger (e.g., transducer) via the connector arranged on the attachment arm 130 in order to register strokes applied to the drum. Therefore, the drumhead dampener apparatus 100 can: register a stroke applied to the drum; and, concurrently, induce an active dampener effect responsive to oscillations across the drumhead of the drum resulting from the stroke applied to the drum.

### 8. DISCLAIMER

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatus 100es and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A drumhead dampener apparatus:
comprising a dampener assembly comprising:
a pouch; and
a weight media arranged within the pouch;
comprising an attachment arm comprising:
a center section:
configured to extend over a rim of a drum; and
comprising a distal end coupled to the pouch of the dampener assembly; and
a first boss:
extending downwardly from a proximal end of the center section opposite the dampener assembly;
configured to receive and compress against a first tension rod extending from a hoop of the drum; and
configured to locate the dampener assembly at a first distance on a drumhead from the rim of the drum; and
wherein the dampener assembly is configured to, in response to application of an impact on the drumhead:
sustain propagation of transient impact vibrations from the drumhead during exciting vibration of the weight media within the pouch; and
attenuate propagation of residual harmonic vibrations from the drumhead during damping vibration of the weight media within the pouch.

2. The drumhead dampener apparatus of claim 1, wherein the center section further comprises a step:
interposed between the first boss and the dampener assembly; and
configured to:
bridge a height difference between the first tension rod and the drumhead;
maintain a distal segment of the center section, adjacent the dampener assembly, parallel to the drumhead; and
reduce torque applied by the weight media to the boss, via the center section, orthogonal to an axis of the tension rod.

3. The drumhead dampener apparatus of claim 1, wherein the center section comprises:
a rigid segment:
proximal the first boss;
defining a first thickness; and
configured to maintain compression of the first boss against the first tension rod during vibration of the weight media within the pouch; and
a flexible segment:
proximal the dampener assembly;
defining a second thickness, less than the first thickness; and
configured to flex during vibration of the weight media within the pouch to induce the active gate-dampening effect.

4. The dampener apparatus of claim 1:
wherein the weight media comprises a unitary weight element defining a slot configured to receive the distal end of the center section; and
wherein the pouch comprises a unitary dampener layer:
enveloping the unitary weight element;
coupled to the distal end of the center section proximal the slot of the weight media; and
configured to contact the drumhead of the drum.

5. The drumhead dampener apparatus of claim 1:
wherein the weight media comprises a set of metallic ball bearings configured to, in response to application of the impact on the drumhead, vibrate within the pouch to:
sustain propagation of transient impact vibrations from the drumhead during exciting vibration of the set of metallic ball bearings within the pouch; and
attenuate propagation of residual harmonic vibrations from the drumhead during damping vibration of the set of metallic ball bearings within the pouch; and
wherein the pouch comprises:
a first layer coupled to a top region of the distal end of the center section; and
a second layer:
coupled to a bottom region of the distal end of the center section;
coupled to a periphery of the first layer to contain the set of metallic ball bearings; and
configured to contact the drumhead of the drum.

6. The drumhead dampener apparatus of claim 5, wherein the weight media further comprises a set of magnetic elements:
arranged within the pouch; and
configured to magnetically couple to the set of metallic ball bearings to attenuate vibration of the set of metallic ball bearings within the pouch in response to external environmental vibrations independent of impact on the drumhead of the drum.

7. The drumhead dampener apparatus of claim 1:
wherein the weight media comprises a unitary weight element configured to, in response to application of the impact on the drumhead, vibrate within the pouch to:
sustain propagation of transient impact vibrations from the drumhead during exciting vibration of the unitary weight element within the pouch; and
attenuate propagation of residual harmonic vibrations from the drumhead during damping vibration of the unitary weight element within the pouch;
wherein the attachment arm is overmolded about the unitary weight element at the distal end of the center section; and
wherein the pouch comprises:
a first layer coupled to a top region of the distal end of the center section; and
a second layer:
coupled to a bottom region of the distal end of the center section;
coupled to a periphery of the first layer to contain the unitary weight element; and
configured to contact the drumhead of the drum.

8. The drumhead dampener apparatus of claim 1:
wherein the dampener assembly defines a dampening threshold proportional to:
a mass of the weight media;
a durometer of the attachment arm; and
the first distance on the drumhead from the rim of the drum; and
wherein the weight media is configured to, following application of the impact on the drumhead, induce an active gate-dampening effect that:
during a first time period and in response to the vibration of the weight media exceeding the dampening threshold, sustains propagation of transient impact vibrations from the drumhead; and
during a second time period following the first time period and in response to vibration of the weight media falling below the dampening threshold, attenuates propagation of residual harmonic vibrations from the drumhead.

9. The drumhead dampener apparatus of claim 1:
wherein, in a first configuration, the first boss is configured to:
receive and compress against the first tension rod extending from the hoop of the drum; and
locate the dampener assembly at the first distance on the drumhead from the rim of the drum; and
wherein, in a second configuration, the first boss is configured to:
receive and compress against a second tension rod, radially offset from the first tension rod, extending from the hoop of the drum; and
locate the dampener assembly at a second distance, offset from the first distance, on the drumhead from the rim of the drum.

10. The drumhead dampener apparatus of claim 1:
wherein, in a first configuration, the first boss is configured to:
receive and compress against a first end of the first tension rod extending from the hoop of the drum; and
locate the dampener assembly at the first distance on a batter head from the rim of the drum; and
wherein, in a second configuration, the first boss is configured to:
receive and compress against a second end, opposite the first end, of the tension rod extending from the hoop of the drum; and
locate the dampener assembly at a second distance on a resonant head, opposite the batter head, from the rim of the drum.

11. The drumhead dampener apparatus of claim 1:
wherein the attachment arm further comprises a second boss:
interposed between the first boss and the dampener assembly; and
extending opposite the first boss;
wherein, in a first configuration, the first boss is configured to:
receive and compress against the first tension rod extending from the hoop of the drum; and
locate the dampener assembly at the first distance on the drumhead from the rim of the drum; and
wherein, in a second configuration, the second boss is configured to:
receive and compress against the first tension rod extending from the hoop of the drum; and
locate the dampener assembly at a second distance, less than the first distance, on the drumhead from the rim of the drum.

12. The drumhead dampener apparatus of claim 1:
wherein the center section further comprises an aperture interposed between the first boss and the dampener assembly;
wherein in a first configuration:
the first boss is configured to:
receive and compress against the first tension rod extending from the hoop of the drum; and
locate the dampener assembly at the first distance on the drumhead from the rim of the drum; and
the dampener assembly is configured to, in response to application of an impact on the drumhead, induce the active gate-dampening effect that:
sustains propagation of transient impact vibrations from the drumhead during exciting vibration of the weight media within the pouch; and
attenuates propagation of residual harmonic vibrations from the drumhead during dampening vibration of the weight media within the pouch; and
wherein in a second configuration:
the aperture is configured to:
receive a post extending from a cymbal seat of a cymbal stand; and
locate the dampener assembly at a second distance on a bow of the cymbal; and
the dampener assembly is configured to, in response to application of an impact on the bow, induce the active gate-dampening effect that:
sustains propagation of transient impact vibrations from the bow during exciting vibration of the weight media within the pouch; and
attenuates propagation of residual harmonic vibrations from the bow during damping vibration of the weight media within the pouch.

13. The drumhead dampener apparatus of claim 1:
wherein the pouch comprises a flexible dampener layer defining a first contact surface across a first region of the drumhead;
wherein the distal end of the center section is coupled to a first edge of the flexible dampener layer; and
wherein the weight media:
comprises a set of discrete weight elements impregnated within the flexible dampener layer; and
configured to maintain contact of the flexible dampener layer across the first region of the drumhead.

14. The drumhead dampener apparatus of claim 13:
wherein the flexible dampener layer comprises:
a first magnetic element proximal the first edge of the flexible dampener layer; and
a second magnetic element proximal a second edge, opposite the first edge, of the flexible dampener layer;
wherein in a first configuration:
the flexible dampener layer defining the first contact surface across the first region of the drumhead; and
wherein in a second configuration:
the second magnetic element magnetically coupled to the first magnetic element to define a second contact surface across a second region, less than the first region, of the drumhead.

15. A drumhead dampener apparatus:
comprising a flexible dampener layer;
comprising an attachment arm comprising:
a center section:
configured to extend over a rim of a drum; and
comprising a distal end coupled to an edge of the flexible dampener layer; and
a first boss:
extending downwardly from a proximal end of the center section opposite the flexible dampener layer;
configured to receive and compress against a first tension rod extending from a hoop of the drum; and
configured to locate the flexible dampener layer across a first region of the drumhead from the rim of the drum; and
wherein the flexible dampener layer is configured to, in response to application of an impact on the drumhead:
sustain propagation of transient impact vibrations from the drumhead during exciting vibration of the flexible dampener layer over the first region of the drumhead; and
attenuate propagation of residual harmonic vibrations from the drumhead during damping vibration of the flexible dampener layer over the first region of the drumhead.

16. The drumhead dampener apparatus of claim 15, wherein the center section further comprises a step:
interposed between the first boss and the flexible dampener layer; and
configured to:
extend across a height difference between the first tension rod and the drumhead;
maintain a distal segment of the center section, adjacent the flexible dampener layer, parallel to the drumhead; and
increase torque, normal to the drumhead, between the first boss and the first tension rod.

17. The drumhead dampener apparatus of claim 15, further comprising:
a rigid segment:
proximal the first boss;
defining a first thickness; and
configured to maintain compression of the first boss against the first tension rod during vibration of the flexible dampener layer over the first region of the drumhead; and
a flex segment:
proximal the dampener assembly;
defining a second thickness, less than the first thickness; and
configured to flex during vibration of the flexible dampener layer over the first region of the drumhead to induce the active gate-dampening effect.

18. The drumhead dampener apparatus of claim 15, further comprising a set of discrete weight elements:
impregnated within the flexible dampener layer; and
configured to maintain contact of the flexible dampener layer across the first region of the drumhead.

19. A drumhead dampener apparatus:
comprising a set of weight elements;
comprising an attachment arm comprising:
a center section:
configured to extend over a rim of a drum; and
comprising a distal end coupled to the set of weight elements; and
a first boss:
extending downwardly from a proximal end of the center section opposite the set of weight elements;
configured to receive and compress against a first tension rod extending from a hoop of the drum; and
configured to locate the set of weight elements at a first distance on the drumhead from the rim of the drum; and
wherein the set of weight elements are configured to, in response to application of an impact on the drumhead:
sustain propagation of transient impact vibrations from the drumhead during exciting vibration of the set of weight elements on the drumhead; and
attenuate propagation of residual harmonic vibrations from the drumhead during damping vibration of the set of weight elements on the drumhead.

20. The drumhead dampener apparatus of claim 19, wherein the center section further comprises a step:
interposed between the first boss and the flexible dampener layer; and
configured to:
extend across a height difference between the first tension rod and the drumhead;
maintain a distal segment of the center section, adjacent the set of weight elements, parallel to the drumhead; and
increase torque, normal to the drumhead, between the first boss and the first tension rod.
